(19) United States
(12) Patent Application Publication
(10) Pub. No.: US 2014/0263251 A1
(43) Pub. Date: Sep. 18, 2014

(54) SPLIT GOOSENECK FOR WELDING GUNS

(71) Applicant: Lincoln Global, Inc., City of Industry, CA (US)

(72) Inventors: Edward A. Enyedy, Eastlake, OH (US); Grant Taylor Sadowski, Painesville, OH (US); Brian David Meess, Willoughby, OH (US); Jeffrey L. Kachline, Highland Heights, OH (US)

(73) Assignee: Lincoln Global, Inc., City of Industry, CA (US)

(21) Appl. No.: 13/804,826

(22) Filed: Mar. 14, 2013

(51) Int. Cl. B23K 9/32

(52) U.S. Cl. CPC B23K 9/325
USPC 219/137.42

(57) ABSTRACT

The invention described herein pertains generally to split goosenecks (synonymously swan necks) having a fixed or non-fixed radius for use with welding guns.

### TECHNICAL FIELD

The invention described herein pertains generally to split goosenecks (synonymously swan necks) having a fixed or non-fixed radius for use with welding guns.

### BACKGROUND OF THE INVENTION

Three important consumables in a welding torch are the contact tip, nozzle and liner. Welding guns make electrical contact with the wire. This electrical contact occurs through a contact tip that the welding wire feeds through. As used in the industry, a contact tip may be tapered or non-tapered. Contact tips also may be threaded or nonthreaded.

The welding nozzle directs the shielding gas to the weld. Like contact tips, nozzles are either threaded or nonthreaded and come in many different shapes and sizes for various applications.

The electrode wire is fed to the welding gun through a cable liner. For steel applications, a spring steel coiled liner is used in that they are rigid, resist buckling and have a long life. Aluminum applications typically require liners made from nylon (polyamides), Teflon®, polyethylene, carbon-Teflon® or high density Teflon® or some type of plastic because these materials have lower friction than steel and they help keep contamination out of the weld. In specialized instances, tungsten or graphite liners are used, graphite being preferred when welding with titanium wire. When aluminum wire is pushed through a steel liner, the wire can pick up bits of steel that can contaminate the weld. Liners need to be replaced because they wear out from continuous use or become kinked from improper use. Liners are positioned within the gooseneck (or swan neck) leading from the welding gun and terminating at the contact tip and nozzle. The gooseneck typically has a constant curvilinear bend over a sweep angle and the liner follows the same curvilinear path.

What is needed is a split neck which facilitates irregular curvilinear paths within the welding gun neck as well as a split neck for facilitating liner replacement even with constant curvilinear pathways within the neck over a sweep angle. This instant invention is applicable to both automatic and manual welding processes.

Thus, in one aspect of the invention, it is considered desirable to provide a split neck assembly for a welding torch with or without a reverse bend thereby facilitating the cleaning of the neck as well as a wider choice of materials for the liner as well as providing more variation in the wire path, which is no longer limited to a bent tube configuration.

### SUMMARY OF THE INVENTION

In accordance with the present invention, in one aspect, there is provided a split neck nozzle for a welding torch.

In one aspect of the invention, the welding torch will include: A welding torch, comprising: a nozzle; a contact tip positioned within the nozzle; a neck extending from the contact tip at one end; a handle connected to the neck at an opposed end; wherein the neck has two fastenable longitudinal components, at least one of the longitudinal components having a curvilinear pathway disposed therein; a guide member positioned within the at least one of said longitudinal components having a curvilinear pathway disposed therein; and a welding wire which is fed through the neck and the guide member positioned within the neck.

In one illustration of the invention, the welding torch will have one longitudinal component which is a cover plate having no curvilinear groove disposed therein, and one longitudinal component which has a curvilinear groove within the curvilinear pathway.

In another illustration, the welding torch of claim 1, will have each longitudinal component with a curvilinear groove within the curvilinear pathway, i.e., a mirror image configuration.

In another aspect of the invention, the welding torch will have one longitudinal component having a curvilinear groove disposed therein which has at least one non-linear portion for the groove over a sweep angle. Optionally, the welding torch will have each of the longitudinal components having a curvilinear groove disposed therein with at least one non-linear portion for the groove over a sweep angle, i.e., a mirror image of each other.

The welding torch may have a curvilinear pathway within the at least one component of said neck which has a variable radius extending from the handle to the nozzle and further wherein a radius of the neck adjacent to the handle (“R_{P}”) is not equal to a radius of the neck adjacent to the contact tip (“R_{d}”).

The curvilinear pathway within the at least one component of the neck may include a series of non-equal radii bends in the range of approximately 0° to 68°.

The invention extends to just a split gooseneck member, having a welding wire retaining component which includes: a longitudinally split wire containing member extending between the contact tip and the handle, at least one wire retaining member having a curvilinear pathway disposed therein; a guide member within the wire retaining member; wherein the wire retaining member has a gooseneck portion having a variable radius extending from the handle to the nozzle and further wherein a radius of the gooseneck adjacent to the handle (“R_{P}”) is not equal to a radius of the gooseneck adjacent to the contact tip (“R_{d}”); and a fastening means for said longitudinally split wire containing member.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a perspective view of a Prior Art welding gun having a reverse bend in the one-piece nozzle;

FIG. 2 is an enlarged cross-sectional view of the welding torch without a reverse bend illustrating a split gooseneck nozzle fastened together using screws;

FIG. 3 is an enlarged cross-sectional view of a self-shielded welding torch without a reverse bend illustrating a curvilinear or serpentine pattern within the split gooseneck;

FIG. 4 is an enlarged perspective view of a gooseneck split into essentially two equal halves; and

FIG. 5 is an enlarged perspective view of a gooseneck split into non-equal halves.

### DETAILED DESCRIPTION OF THE INVENTION

The best mode for carrying out the invention will now be described for the purposes of illustrating the best mode known to the applicant at the time of the filing of this patent application. The examples and figures are illustrative only and not meant to limit the invention, which is measured by the scope and spirit of the claims.

Referring to FIG. 1, a prior art welding gun nozzle is shown having a reverse bend in the nozzle on an end of a nozzle tube which extends to the left in an arcuate manner to guide electrode E and shielding gases to contact tip 12 and gas nozzle 14. One-Piece gooseneck tube 16 is formed of high conductivity copper material and is generally cylindrical in its external shape, although it may be any shape. Tube 16 can have an internal non-cylindrical passage such as a polygonal shape, preferably square, although most internal passages are round. Inside of the passage is a cylindrical steel tube and a cylindrical electrode wire guide formed of an elongated helix of spring steel (or other composition) welding wire having an outer diameter generally equal to the smallest transverse dimension of the passage. With the cylindrical configuration of tube and guide and the non-cylindrical e.g. polygonal configuration of the passage shown, there is ample clear space for gas flow from the handle through the nozzle tube to gas nozzle 14. The inner diameter of the guide is such as to appropriately mate with the size of electrode E to be moved therethrough.

The outer surface of tube 16 is encased in insulating coating 24 as is conventional. Gooseneck tube 16 has curved portion 25 with a radius R₁ as it leaves handle 26 housing, switch 28 having operating button 30, and terminating in short portion 31 with a reverse radius R₂.

The exit end of nozzle tube 16 is counterbored and threaded to receive the threaded end of gas diffuser 34 which when threaded into position holds sleeve 36 surrounding the exit end of the nozzle tube by means of a flange on the end of sleeve being engaged by a shoulder on the gas diffuser. An outer surface of another sleeve 32 is threaded as at 38 to mate with internal threads on nozzle 14.

Gas diffuser 34 has an entrant internal passage greater than the diameter of electrode E, and a plurality of radial passages extending from this passage through which gases can flow into the interior of the gas nozzle. The lower end of the gas diffuser can be counterbored and threaded to threadably receive contact tip 12 coaxial with the gas nozzle and terminating at its exit end short of the lower or exit end of the gas nozzle. The contact tip has a passage therethrough of a diameter just slightly greater than the diameter of the electrode E with which the gun is to be used. Because of the reverse radius R₂, electrode E is biased against one side of contact tip 12 to provide electrical contact with the electrode E at a fixed point close to where the electrode exits tip 12. While electrical contact may be enhanced due to the reverse bend radius R₂, feeding of the electrode through the gun may be inhibited, depending on the severity of the reverse angle.

Electrodes over the years have been developed which have smaller diameters and have thinner metal sheaths or jackets. As a result, the electrodes are less rigid and are more susceptible to feeding and binding problems. Common feeding problems are slipping at the drive rolls that feed the electrode or buckling of the electrode right after the drive rolls. By removing the reverse bend in the nozzle, feeding of the electrode is improved and bending is reduced.

Performance of a torch assembly depends on several factors, such as electrode diameter, stiffness, and surface condition. For larger diameter and stiffer electrodes, a fixed gooseneck bend in the range of approximately 0° to 68° with a reverse bend adjacent the contact tip will give the best combination of feeding and arc stability. For smaller diameter and less rigid electrodes, a nozzle assembly with a goose-neck bend in the range of approximately 30° to 90° without a reverse bend will result in an optimum performance.

Referring now to FIG. 2, an enlarged cross-sectional view of the welding torch in accordance with a preferred embodiment of the present invention is shown. For this embodiment, the invention will be described herein with reference to self-shielded or gas shielded welding guns or torches.

Referring to FIG. 2, gas-shielded welding torch 100 without a reverse bend is shown in position above Workpiece (“W”) 102 which is typically connected by means of a ground wire to a welding power supply (not shown). Welding torch 100 is typically supplied with electrode wire 104 (e.g., steel, aluminum, alloys, composites, etc., or other welding wire known to those in the art) from a wire supply reel via a control system. The control system not only regulates the rate at which welding wire 104 moves into the torch, but it can also regulate the flow of shielding gas from a gas source.

Nozzle 108, includes contact tip 110 having formed therein a passageway 112 through which welding wire 104 is directed into the weld. Split gooseneck tube 114a, 114b is preferably formed of high conductivity copper material and is generally cylindrical in its external shape, although it may be any suitable shape. The tube has internal non-cylindrical passage 116 such as a polygonal shape, preferably square. Inside of the passage is a cylindrical steel tube and a liner or cylindrical electrode wire guide 118 formed of an elongated helix of spring steel wire having an outer diameter generally equal to the smallest transverse dimension of the passage. The electrode wire is fed to the welding gun through cylindrical electrode wire guide or cable liner 118. For steel applications, a spring steel coiled liner is used in that they are rigid, resist buckling and have a long life. Aluminum applications typically require liners made from nylon (polyamides), Teflon®, polyethylene, carbon-Teflon® or high density Teflon® or some type of plastic because these materials have lower friction than steel and they help keep contamination out of the weld. In specialized instances, tungsten or graphite liners are used, graphite being preferred when welding with titanium wire. When aluminum wire is pushed through a steel liner, the wire can pick up bits of steel that can contaminate the weld. Liners need to be replaced because they wear out from continuous use or become kinked from improper use. Liners are positioned within the gooseneck (or swan neck) leading from the welding gun and terminating at the contact tip and nozzle.

The outer surface of split gooseneck tube 114a, 114b is encased in insulating coating 120 as is conventional. Split gooseneck tube 114a, 114b has a radius R as it leaves handle 122 terminating in short portion 124. Curved portion 115 of the gooseneck extends between handle 122 and nozzle 108. The gooseneck, as can be seen in FIG. 2, has a variable (or non-constant) radius R extending between a proximal end adjacent the handle (“Rₚ”) and a distal end (“R_{d}”) adjacent the nozzle over a sweep angle θ and wherein Rₚ≠R_{d}. Sweep angle θ begins post the straight portion of the gooseneck as it exits the handle and ends after the curvilinear portion prior to entry into the nozzle. In a more preferred embodiment, the respective lengths will have the relationship of Rₚ>R_{d}.

Positioned adjacent the exit end of the nozzle tube in polygonal passage 116 is cylindrical ceramic guide 126 which abuts against the left hand or exit end of guide 118 and is held in place by a pair of setscrews 128. Ceramic guide 126 has a cylindrical outer surface to permit the passage of the shielding gases thereby in the spaces provided by the square shape of the bore and a central opening through which electrode E passes.

The left hand or exit end of the nozzle tube is counterbored and threaded as at 130 to receive the threaded end of gas diffuser 132 which when threaded into position holds a sleeve surrounding the left hand or exit end of tube 114 by means of flange 134 on the end of sleeve 136 being engaged by shoulder 138 on gas diffuser 132. The outer surface of sleeve 136 is threaded as at 140 to mate with internal threads 142 on the nozzle.

Gas diffuser 132 has an entrant internal passage 144 greater than the diameter of electrode wire E, and a plurality of radial passages 146 extending from this passage through which gases can flow into the interior of the gas nozzle. The lower end of gas diffuser 132 is counterbored and threaded as at 148 to threadably receive contact tip 110 coaxial with the gas nozzle and terminating at its exit end short of the lower or exit end of the gas nozzle. The contact tip has passage 112 therethrough of a diameter just slightly greater than the diameter of the electrode wire E with which the gun is to be used. The gun further includes handle 122 with a microswitch mounted thereon having an operating button which must be depressed.

Referring still to FIG. 2, adjacent the contact tip of the nozzle, the gooseneck tube does not have a reverse bend as does the nozzle of FIG. 1. Rather, the gooseneck tube extends so that the contact tip and the short portion 124 of the tube has a longitudinal axis substantially collinear with longitudinal axis 150 of the contact tip. Thus, no reverse bend is present. By not having a reverse bend, pressure between the electrode and contact tip is reduced, thus reducing drag on the electrode as it is fed through the gun. It should be recognized that while no reverse bend is preferred, it is not precluded and at a minimum, the Rₚ and R_{d} difference permits the severity of the reverse bend to be decreased.

The nozzle assembly that delivers the best performance can vary depending on many factors. Some of the factors are electrode diameter, stiffness, and surface condition. For smaller diameter and less rigid electrodes an approximately 30° to 90° nozzle assembly without a reverse bend will give the best performance. For larger diameter and stiffer electrodes an approximately 0° to 68° degree nozzle assembly with a slight reverse bend will give the best combination of feeding and arc stability. Thus, a slight reverse bend may be permissible without adversely affecting the feeding of wire through the nozzle.

Split gooseneck 114a, 114b is fastened together by a fastening means 152, including, but not limited to screws, clips, or other devices applicable to securing component parts together. While “ears” are illustrated in FIG. 2, as illustrated in FIGS. 4-5, the fastening means may be bored into the separate components of the gooseneck.

Referring now to FIG. 3, a serpentine or curvilinear path is illustrated within the gooseneck for guide 118. As is commonly known in the art, a liner or spring assembly 118 can surround wire 104 within the nozzle and serves to center and position the wire within the nozzle sleeve and assist the wire in moving through the central part of the sleeve.

Referring now to FIG. 4, the split gooseneck may be essentially two equal halves 114a, 114b with a central groove positioned within each for liner or spring assembly 118 to be positioned therein, or may be of unequal components, 114c, 114d in which the central groove is only positioned within one of the two component parts as better illustrated in FIG. 5 and the non-grooved component is a cover plate. In these figures, fastening means 152 are illustrated to be a screw 154 which is inserted into bored aperture 154 to be threadably fastened into internally threaded bore 158.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A welding torch, comprising:
a nozzle;
a contact tip positioned within said nozzle;
a neck extending from said contact tip at one end;
a handle connected to said neck at an opposed end;
wherein said neck has two fastenable longitudinal components, at least one of said longitudinal components having a curvilinear pathway disposed therein;
a guide member positioned within said at least one of said longitudinal components having a curvilinear pathway disposed therein; and
a welding wire which is fed through said neck and said guide member positioned within said neck.

2. The welding torch of claim 1, wherein
one longitudinal component is a cover plate having no curvilinear groove disposed therein, and
one longitudinal component has a curvilinear groove within said curvilinear pathway.

3. The welding torch of claim 1, wherein
each longitudinal component has a curvilinear groove within said curvilinear pathway.

4. The welding torch of claim 3 wherein
each longitudinal component is a mirror image of the other.

5. The welding torch of claim 2, wherein
said one longitudinal component having a curvilinear groove disposed therein has at least one non-linear portion for said groove over a sweep angle.

6. The welding torch of claim 3, wherein
each of said longitudinal components having a curvilinear groove disposed therein has at least one non-linear portion for said groove over a sweep angle.

7. The welding torch of claim 6, wherein
each longitudinal component is a mirror image of the other.

8. The welding torch of claim 1, wherein
said curvilinear pathway within said at least one component of said neck has a variable radius extending from said handle to said nozzle and further wherein a radius of said neck adjacent to said handle (“Rₚ”) is not equal to a radius of said neck adjacent to said contact tip (“R_{d}”).

9. The welding torch of claim 1, wherein
said curvilinear pathway within said at least one component of said neck comprises a series of non-equal radii bends in the range of approximately 0° to 68°.

10. A welding torch assembly, comprising:
a contact tip;
a handle;
a longitudinally split wire containing member extending between said contact tip and said handle, at least one wire containing member having a curvilinear pathway disposed therein;
a guide member within said wire retaining member;
wherein said wire retaining member has a gooseneck portion having a variable radius extending from said handle to said nozzle and further wherein a radius of said gooseneck adjacent to said handle (“R_{P}”) is not equal to a radius of said gooseneck adjacent to said contact tip (“R_{d}”); and
a fastening means for said longitudinally split wire containing member; and
a welding wire disposed within said guide member.

11. The welding torch of claim 10, further comprising:
one split wire containing member is a cover plate having no curvilinear groove disposed therein, and
one split wire containing member has a curvilinear groove disposed within said curvilinear pathway.

12. The welding torch of claim 10, wherein
each split wire containing member has a curvilinear groove disposed within said curvilinear pathway.

13. The welding torch of claim 12, wherein
each split wire containing member is a mirror image of the other.

14. The welding torch of claim 11, wherein
said one split wire containing member having a curvilinear groove disposed therein has at least one non-linear portion for said groove over a sweep angle.

15. The welding torch of claim 12, further comprising
each of said longitudinal components having a curvilinear groove disposed therein has at least one non-linear portion for said groove over a sweep angle.

16. The welding torch of claim 15, wherein
each longitudinal component is a mirror image of the other.

17. The welding torch of claim 10, wherein
said gooseneck portion of said tube comprises a series of non-equal radii bends in the range of approximately 0° to 68°.

18. A welding wire retaining component, comprising:
a longitudinally split wire containing member extending between said contact tip and said handle, at least one wire retaining member having a curvilinear pathway disposed therein;
a guide member within said wire retaining member;
wherein said wire retaining member has a gooseneck portion having a variable radius extending from said handle to said nozzle and further wherein a radius of said gooseneck adjacent to said handle (“R_{P}”) is not equal to a radius of said gooseneck adjacent to said contact tip (“R_{d}”); and
a fastening means for said longitudinally split wire containing member; and

19. The welding torch of claim 18, wherein
said gooseneck portion of said tube comprises a series of non-equal radii bends in the range of approximately 30° to 90°;
one split wire containing member is a cover plate having no curvilinear groove disposed therein, and
one split wire containing member has a curvilinear groove disposed within said curvilinear pathway.

20. The welding torch of claim 18, wherein
said gooseneck portion of said tube comprises a series of non-equal radii bends in the range of approximately 30° to 90°;
each split wire containing member has a curvilinear groove disposed within said curvilinear pathway.
